(19) United States
(12) Patent Application Publication
(10) Pub. No.: US 2022/0271815 A1
(43) Pub. Date: Aug. 25, 2022

(54) Reduction of Overhead Associated with Configuration of Transmission Functions Relating to Sounding Reference Signals

(71) Applicant: Apple Inc., Cupertino, CA (US)

(72) Inventors: Yushu Zhang, Beijing (CN); Yang Tang, Cupertino, CA (US); Fangli Xu, Beijing (CN); Chunhai Yao, Beijing (CN); Yuchul Kim, Santa Clara, CA (US); Hong He, Cupertino, CA (US); Chunxuan Ye, San Diego, CA (US); Weidong Yang, San Diego, CA (US); Haitong Sun, Irvine, CA (US); Haijing Hu, Beijing (CN); Dawei Zhang, Saratoga, CA (US); Wei Zeng, San Diego, CA (US)

(21) Appl. No.: 17/050,789

(22) PCT Filed: Nov. 28, 2019
(86) PCT No.: PCT/CN2019/121628

§ 371 Date: Oct. 26, 2020

(51) Int. Cl. H04B 7/06; H04L 5/00

(52) U.S. Cl. CPC H04B 7/0686; H04L 5/0048

(57) ABSTRACT

A base station may configure a user equipment (UE) to perform sounding reference signal (SRS) transmissions using an SRS resource set. The SRS resource set may be configured for two or more functions, e.g., functions such as codebook-based SRS transmission, non-codebook-based SRS transmission, antenna port switching, beam management, etc. By enabling the use of such dual function (or multi-function) SRS resource sets, the average data rate associated with configuration transmissions to the UE may be reduced.

### FIELD

The present disclosure relates to the field of wireless communication, and more particularly, to mechanisms enabling the reduction of transmission overhead associated with the use of sounding reference signals (SRS).

### DESCRIPTION OF THE RELATED ART

A wireless user equipment (UE) device may transmit sounding reference signals to a base station, to enable the base station to estimate the transmission channel between the UE device and the base station. (The base station may use the channel estimate to perform demodulation of uplink data transmitted by the UE device.) The base station may a transmit a configuration message to the UE device, to configure a set of time-frequency resources for SRS transmission. It would be desirable to reduce the number of such messages per unit time.

### SUMMARY

In one set of embodiments, a base station may configure an SRS resource set for two or more functions, e.g., for codebook-based SRS transmission with antenna switching, or for non-codebook based SRS transmission with antenna switching, or for codebook based SRS transmission and beam management, or for non-codebook based SRS transmission and beam management, etc. By combining different functions in a single SRS resource set, the number of SRS resource sets needed to achieve a given combination of functions, and thus, the overhead for downlink transmission of SRS configuration information may be reduced.

In some embodiments, the UE may decide for itself whether a resource set is to be used for more than one function, e.g., by evaluating one or more predefined or predetermined conditions.

In some embodiments, a method for operating a wireless user equipment (UE) device may be implemented as follows. The method may include performing operations on a processing element, wherein the operation include performing transmissions of sounding reference signals (SRSs) with antenna port switching in a resource set.

In some embodiments, the SRSs may be associated with Physical Uplink Shared Channel (PUSCH) transmission for codebook based transmission scheme. In these embodiments, the first resource set may be configured using a value of a usage parameter that indicates codebook usage and antenna switching.

In some embodiments, the SRSs may be associated with Physical Uplink Shared Channel (PUSCH) transmission for non-codebook based transmission scheme In these embodiments, the first resource set may be configured using a value of a usage parameter that indicates codebook usage and antenna switching

In some embodiments, a method for operating a wireless user equipment (UE) device may be implemented as follows. The method may involve performing operations on a processing element. The operations may include performing transmission of sounding reference signals (SRSs) in a resource set, wherein the transmissions conform to a beam management function and a second transmission function, wherein the second transmission function is codebook based or non-codebook based. In these embodiments, the first resource set may be configured using a value of a usage parameter that indicates either codebook usage and beam management, or non-codebook usage and beam management.

### BRIEF DESCRIPTION OF THE DRAWINGS

A better understanding of the present subject matter can be obtained when the following detailed description of the preferred embodiment is considered in conjunction with the following drawings.

FIGS. 1-2 illustrate examples of wireless communication systems, according to some embodiments.

FIG. 3 illustrates an example of a base station in communication with a user equipment device, according to some embodiments.

FIG. 4 illustrates an example of a block diagram of a user equipment device, according to some embodiments.

FIG. 5 illustrates an example of a block diagram of a base station, according to some embodiments.

FIG. 6 illustrates an example of a user equipment device 600, according to some embodiments.

FIG. 7 illustrates an example of a base station 700, according to some embodiments. The base station 700 may be used to communicate with user equipment 600 of FIG. 6.

FIG. 8 illustrates an example where a sounding reference signal (SRS) resource set is used for both codebook and antenna switching, according to some embodiments.

FIG. 9 illustrates an example where a UE configured for full power transmission mode 2 performs antenna switching in an SRS resource set configured for codebook usage, according to some embodiments.

FIG. 10 illustrates an example where a UE configured for full power transmission mode 2 does not perform antenna switching in an SRS resource set configured for codebook usage, according to some embodiments.

FIG. 11 illustrates an example where a UE configured for a transmission mode other than full power transmission mode 2 performs antenna switching in a resource set configured for codebook usage, according to some embodiments.

FIG. 12 illustrates an example where a UE performs antenna switching in a resource set configured for non-codebook usage, according to some embodiments.

FIG. 13 illustrates an example of a method for performing transmissions of SRSs, according to some embodiments.

FIG. 14 illustrates an example where an SRS resource set may be configured for codebook (or non-codebook) usage and beam management, according to some embodiments.

FIG. 15 illustrates an example of a method for performing transmissions of SRSs, where the transmission conform to a beam management function and a second transmission function, according to some embodiments.

FIG. 16 illustrates an example of a method for performing SRS transmission according to two or more transmission-related functions, according to some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION OF THE EMBODIMENTS

### Acronyms

The following acronyms are used in this disclosure.
3GPP: Third Generation Partnership Project
3GPP2: Third Generation Partnership Project 2
5G NR: 5^{th} Generation New Radio
BW: Bandwidth
BWP: Bandwidth Part
CA: Carrier Aggregation
CQI: Channel Quality Indictor
CSI: Channel State Information
DC: Dual Connectivity
DCI: Downlink Control Information
DL: Downlink
eNB (or eNodeB): Evolved Node B, i.e., the base station of 3GPP LTE
eUICC: embedded UICC
gNB (or gNodeB): next Generation NodeB, i.e., the base station of 5G NR
GSM: Global System for Mobile Communications
HARQ: Hybrid ARQ
LTE: Long Term Evolution
LTE-A: LTE-Advanced
MAC: Medium Access Control
MAC-CE: MAC Control Element
NR: New Radio
NR-DC: NR Dual Connectivity
NW: Network
PDCCH: Physical Downlink Control Channel
PDSCH: Physical Downlink Shared Channel
PUCCH: Physical Uplink Control Channel
PUSCH: Physical Uplink Shared Channel
RACH: Random Access Channel
RAT: Radio Access Technology
RLC: Radio Link Control
RLM: Radio Link Monitoring
RRC: Radio Resource Control
RRM: Radio Resource Management
RS: Reference Signal
SR: Scheduling Request
SRS: Sounding Reference Signal
SSB: Synchronization Signal Block
UCI: Uplink Control Information
UE: User Equipment
UL: Uplink
UMTS: Universal Mobile Telecommunications System

### Terms

The following is a glossary of terms used in this disclosure:

Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System—any of various types of computing or processing systems, including a personal computer system (PC), mainframe computer system, workstation, network appliance, Internet appliance, personal digital assistant (PDA), personal communication device, smart phone, television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™ PlayStation Portable™, Gameboy Advance™, iPhone™), wearable devices (e.g., smart watch, smart glasses), laptops, PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element—refers to any of various elements or combinations of elements. Processing elements include, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

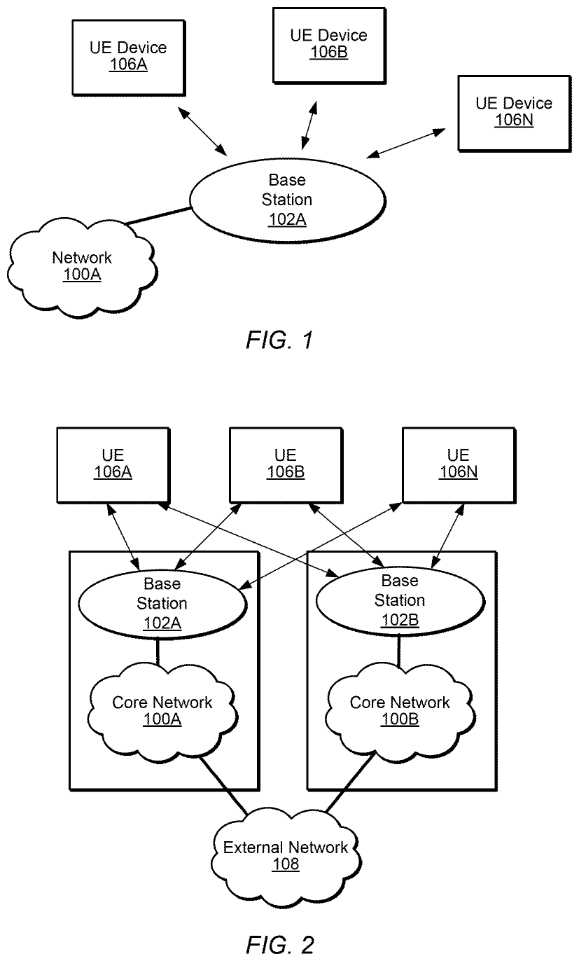

### FIGS. 1-3: Communication System

FIGS. 1 and 2 illustrate exemplary (and simplified) wireless communication systems. It is noted that the systems of FIGS. 1 and 2 are merely examples of certain possible systems, and various embodiments may be implemented in any of various ways, as desired.

The wireless communication system of FIG. 1 includes a base station 102A which communicates over a transmission medium with one or more user equipment (UE) devices 106A, 106B, etc., through 106N. Each of the user equipment devices may be referred to herein as “user equipment” (UE). In the wireless communication system of FIG. 2, in addition to the base station 102A, base station 102B also communicates (e.g., simultaneously or concurrently) over a transmission medium with the UE devices 106A, 106B, etc., through 106N.

The base stations 102A and 102B may be base transceiver stations (BTSs) or cell sites, and may include hardware that enables wireless communication with the user devices 106A through 106N. Each base station 102 may also be equipped to communicate with a core network 100 (e.g., base station 102A may be coupled to core network 100A, while base station 102B may be coupled to core network 100B), which may be a core network of a cellular service provider. Each core network 100 may be coupled to one or more external networks (such as external network 108), which may include the Internet, a Public Switched Telephone Network (PSTN), or any other network. Thus, the base station 102A may facilitate communication between the user devices and/or between the user devices and the network 100A; in the system of FIG. 2, the base station 102B may facilitate communication between the user devices and/or between the user devices and the network 100B.

The base stations 102A and 102B and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), 5G NR, 3GPP2 CDMA2000 (e.g., 1×RTT, 1×EV-DO, HRPD, eHRPD), Wi-Fi, WiMAX, etc.

For example, base station 102A and core network 100A may operate according to a first cellular communication standard (e.g., 5G NR) while base station 102B and core network 100B operate according to a second (e.g., different) cellular communication standard (e.g., LTE, GSM, UMTS, and/or one or more CDMA2000 cellular communication standards). The two networks may be controlled by the same network operator (e.g., cellular service provider or “carrier”), or by different network operators. In addition, the two networks may be operated independently of one another (e.g., if they operate according to different cellular communication standards), or may be operated in a somewhat coupled or tightly coupled manner.

Note also that while two different networks may be used to support two different cellular communication technologies, such as illustrated in the network configuration shown in FIG. 2, other network configurations implementing multiple cellular communication technologies are also possible. As one example, base stations 102A and 102B might operate according to different cellular communication standards but couple to the same core network. As another example, multi-mode base stations capable of simultaneously supporting different cellular communication technologies (e.g., 5G NR, LTE, CDMA 1×RTT, GSM and UMTS, or any other combination of cellular communication technologies) might be coupled to a core network that also supports the different cellular communication technologies. Any of various other network deployment scenarios are also possible.

As a further possibility, it is also possible that base station 102A and base station 102B may operate according to the same wireless communication technology (or an overlapping set of wireless communication technologies). For example, base station 102A and core network 100A may be operated by one cellular service provider independently of base station 102B and core network 100B, which may be operated by a different (e.g., competing) cellular service provider. Thus, in this case, despite utilizing similar and possibly compatible cellular communication technologies, the UE devices 106A-106N might communicate with the base stations 102A-102B independently, possibly by utilizing separate subscriber identities to communicate with different carriers' networks.

A UE 106 may be capable of communicating using multiple wireless communication standards. For example, a UE 106 might be configured to communicate using either or both of a 3GPP cellular communication standard (such as 5G NR or LTE) or a 3GPP2 cellular communication standard (such as a cellular communication standard in the CDMA2000 family of cellular communication standards). As another example, a UE 106 might be configured to communicate using different 3GPP cellular communication standards (such as two or more of GSM, UMTS, LTE, LTE-A and 5G NR). Thus, as noted above, a UE 106 might be configured to communicate with base station 102A (and/or other base stations) according to a first cellular communication standard (e.g., 5G NR) and might also be configured to communicate with base station 102B (and/or other base stations) according to a second cellular communication standard (e.g., LTE, one or more CDMA2000 cellular communication standards, UMTS, GSM, etc.).

Base stations 102A and 102B and other base stations operating according to the same or different cellular communication standards may thus be provided as one or more networks of cells, which may provide continuous or nearly continuous overlapping service to UEs 106A-106N and similar devices over a wide geographic area via one or more cellular communication standards.

A UE 106 might also or alternatively be configured to communicate using WLAN, Bluetooth, one or more global navigational satellite systems (GNSS, e.g., GPS or GLONASS), one and/or more mobile television broadcasting standards (e.g., ATSC-M/H or DVB-H), etc. Other combinations of wireless communication standards (including more than two wireless communication standards) are also possible.

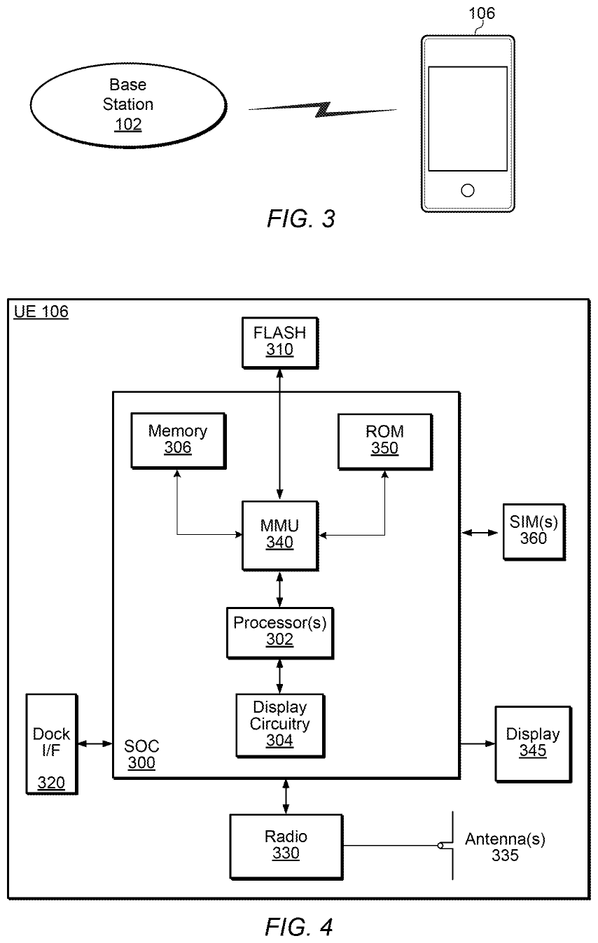

FIG. 3 illustrates user equipment 106 (e.g., one of the devices 106A through 106N) in communication with a base station 102 (e.g., one of the base stations 102A or 102B). The UE 106 may be a device with wireless network connectivity such as a mobile phone, a hand-held device, a computer or a tablet, a wearable device or virtually any type of wireless device.

The UE may include a processor that is configured to execute program instructions stored in memory. The UE may perform any of the method embodiments described herein by executing such stored instructions. Alternatively, or in addition, the UE may include a programmable hardware element such as an FPGA (field-programmable gate array) that is configured to perform any of the method embodiments described herein, or any portion of any of the method embodiments described herein.

The UE 106 may be configured to communicate using any of multiple wireless communication protocols. For example, the UE 106 may be configured to communicate using two or more of GSM, UMTS (W-CDMA, TD-SCDMA, etc.), CDMA2000 (1×RTT, 1×EV-DO, HRPD, eHRPD, etc.), LTE, LTE-A, 5G NR, WLAN, or GNSS. Other combinations of wireless communication standards are also possible.

The UE 106 may include one or more antennas for communicating using one or more wireless communication protocols. Within the UE 106, one or more parts of a receive and/or transmit chain may be shared between multiple wireless communication standards; for example, the UE 106 might be configured to communicate using either (or both) of GSM or LTE using a single shared radio. The shared radio may include a single antenna, or may include multiple antennas (e.g., for MIMO or beamforming) for performing wireless communications. MIMO is an acronym for Multi-Input Multiple-Output.

### FIG. 4—Example of Block Diagram of a UE

FIG. 4 illustrates an example of a block diagram of a UE 106. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 345. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector

I/F 320, and/or display 345. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including Flash memory 310), a connector interface 320 (e.g., for coupling to a computer system, dock, charging station, etc.), the display 345, and radio 330.

The radio 330 may include one or more RF chains. Each RF chain may include a transmit chain, a receive chain, or both. For example, radio 330 may include two RF chains to support dual connectivity with two base stations (or two cells). The radio may be configured to support wireless communication according to one or more wireless communication standards, e.g., one or more of GSM, UMTS, LTE, LTE-A, 5G NR, WCDMA, CDMA2000, Bluetooth, Wi-Fi, GPS, etc.

The radio 330 couples to antenna subsystem 335, which includes one or more antennas. For example, the antenna subsystem 335 may include a plurality of antennas to support applications such as dual connectivity or MIMO or beamforming. The antenna subsystem 335 transmits and receives radio signals to/from one or more base stations or devices through the radio propagation medium, which is typically the atmosphere.

In some embodiments, the processor(s) 302 may include a baseband processor to generate uplink baseband signals and/or to process downlink baseband signals. The processor(s) 302 may be configured to perform data processing according to one or more wireless telecommunication standards, e.g., one or more of GSM, UMTS, LTE, LTE-A, 5G NR, WCDMA, CDMA2000, Bluetooth, Wi-Fi, GPS, etc.

The UE 106 may also include one or more user interface elements. The user interface elements may include any of various elements, such as display 345 (which may be a touchscreen display), a keyboard (which may be a discrete keyboard or may be implemented as part of a touchscreen display), a mouse, a microphone and/or speakers, one or more cameras, one or more sensors, one or more buttons, sliders, and/or dials, and/or any of various other elements capable of providing information to a user and/or receiving/interpreting user input.

As shown, the UE 106 may also include one or more subscriber identity modules (SIMs) 360. Each of the one or more SIMs may be implemented as an embedded SIM (eSIM), in which case the SIM may be implemented in device hardware and/or software. For example, in some embodiments, the UE 106 may include an embedded UICC (eUICC), e.g., a device which is built into the UE 106 and is not removable. The eUICC may be programmable, such that one or more eSIMs may be implemented on the eUICC. In other embodiments, the eSIM may be installed in UE 106 software, e.g., as program instructions stored on a memory medium (such as memory 306 or Flash 310) executing on a processor (such as processor 302) in the UE 106. As one example, a SIM 360 may be an application which executes on a Universal Integrated Circuit Card (UICC). Alternatively, or in addition, one or more of the SIMs 360 may be implemented as removeable SIM cards.

The processor 302 of the UE device 106 may be configured to implement part or all of the methods described herein, e.g., by executing program instructions stored on a memory medium (e.g., a non-transitory computer-readable memory medium). In other embodiments, processor 302 may be configured as or include: a programmable hardware element, such as an FPGA (Field Programmable Gate Array); or an ASIC (Application Specific Integrated Circuit); or a combination thereof.

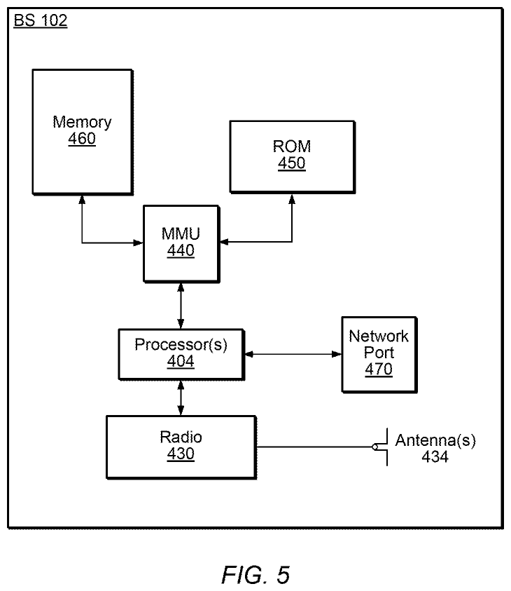

### FIG. 5—Example of a Base Station

FIG. 5 illustrates a block diagram of a base station 102. It is noted that the base station of FIG. 5 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory ROM 450) or to other circuits or devices.

The base station 102 may include at least one network port 470. The network port 470 may be configured to couple to a telephone network and provide access (for a plurality of devices, such as UE devices 106) to the telephone network, as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The base station 102 may include a radio 430 having one or more RF chains. Each RF chain may include a transmit chain, a receive chain, or both. (For example, the base station 102 may include at least one RF chain per sector or cell.) The radio 430 couples to antenna subsystem 434, which includes one or more antennas. Multiple antennas would be needed, e.g., to support applications such as MIMO or beamforming. The antenna subsystem 434 transmits and receives radio signals to/from UEs through the radio propagation medium (typically the atmosphere).

In some embodiments, the processor(s) 404 may include a baseband processor to generate downlink baseband signals and/or to process uplink baseband signals. The baseband processor 430 may be configured to operate according to one or more wireless telecommunication standards, including, but not limited to, GSM, LTE, LTE-A, 5G NR, WCDMA, CDMA2000, etc.

The processor(s) 404 of the base station 102 may be configured to implement part or all of the methods described herein, e.g., by executing program instructions stored on a memory medium (e.g., a non-transitory computer-readable memory medium). In some embodiments, the processor(s) 404 may include: a programmable hardware element, such as an FPGA (Field Programmable Gate Array); or an ASIC (Application Specific Integrated Circuit); or a combination thereof.

### Wireless User Equipment Device 600

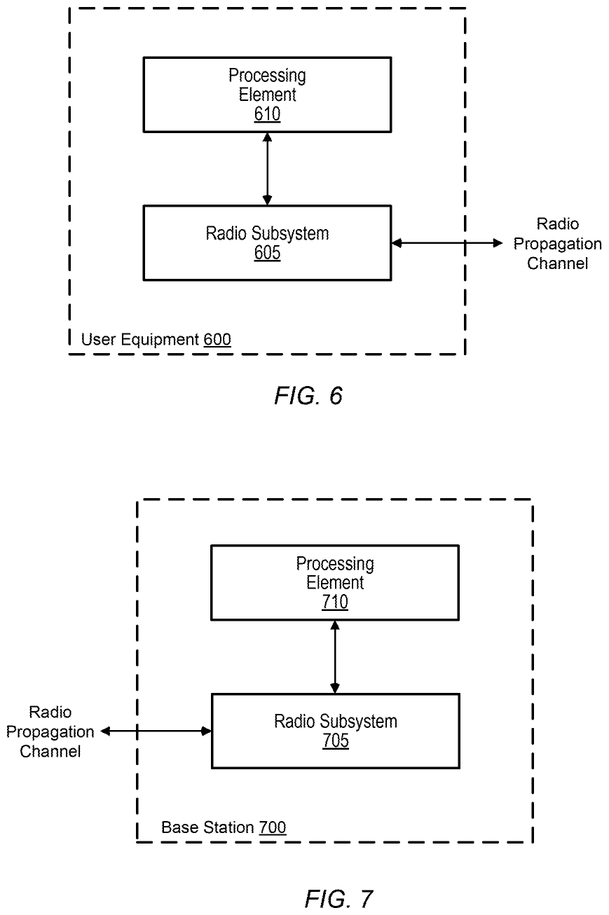

In some embodiments, a wireless user equipment (UE) device 600 may be configured as shown in FIG. 6. UE device 600 may include: a radio subsystem 605 for performing wireless communication; and a processing element 610 operatively coupled to the radio subsystem. (UE device 600 may also include any subset of the UE features described above, e.g., in connection with FIGS. 1-4.)

The radio subsystem 605 may include one or more RF chains, e.g., as variously described above. Each RF chain may be configured to receive signals from the radio propagation channel and/or transmit signals onto the radio propagation channel. Thus, each RF chain may include a transmit chain and/or a receive chain. The radio subsystem 605 may be coupled to one or more antennas (or arrays of antennas) to facilitate signal transmission and reception. Each RF chain (or, some of the RF chains) may be tunable to a desired frequency, thus allowing the RF chain to receive or transmit at different frequencies at different times.

The radio subsystem 605 may be coupled to one or more antenna panels (or antenna arrays), e.g., to support beamforming of received downlink signals and/or transmitted uplink signals.

The processing element 610 may be coupled to the radio subsystem, and may be configured as variously described above. (For example, the processing element may be realized by processor(s) 302.) The processing element may be configured to control the state of each RF chain in the radio subsystem.

In some embodiments, the processing element may include one or more baseband processors to (a) generate baseband signals to be transmitted by the radio subsystem and/or (b) process baseband signals provided by the radio subsystem.

In various embodiments described herein, when a processing element of a wireless user equipment device is said to transmit and/or receive information to/from a wireless base station (or Transmission-Reception Point), it should be understood that such transmission and/or reception occurs by the agency of a radio subsystem such as radio subsystem 605. Transmission may involve the submission of signals and/or data to the radio subsystem, and reception may involve the action of receiving signals and/or data from the radio subsystem.

In some embodiments, the UE device 600 may include beamforming circuitry. The beamforming circuitry may be configured to receive downlink signals from respective antennas of an antenna array of the UE device, and to apply receive beamforming to the downlink signals. For example, the beamforming circuitry may apply weights (e.g., complex weights) to the respective downlink signals, and then combine the weighted downlink signals to obtain a beam signal, where the weights define a reception beam. The beamforming circuitry may also be configured to apply weights to respective copies of an uplink signal, and to transmit the weighted uplink signals via respective antennas of the antenna array of the UE device, wherein the weights define a transmission beam. In some embodiments, beamforming may be applied to transmissions of the Physical Uplink Control Channel (PUCCH) and the Physical Uplink Shared Channel (PUSCH). The UE device apply beamforming to target different transmissions (e.g., PUCCH transmissions, or PUSCH transmissions) to different Transmission-Reception Points (TRPs), e.g., base stations.

In some embodiments, the beamforming circuitry may be implemented by (or included in) the processing element 610. In other embodiments, beamforming circuitry may be included in the radio subsystem 605.

In some embodiments, the UE device 600 (e.g., the processing element 610) may be configured to receive configuration messages from the base station. Configuration message may direct the UE device to set parameters for control behavior of the UE device to make and report measurements to the base station, etc. Configuration messages may request any of different types of reporting, e.g., periodic, semi-static, aperiodic, etc. Configuration messages may indicate any of different types of measurements, e.g., signal to interference-and-noise ratio (SINR), any of various types of channel quality information (CQI), reference signal receiver power (RSRP), etc.

In some embodiments, the radio subsystem 605 may be configured to transmit and receive in a plurality of frequency bands (or frequency ranges). One or more of those frequency bands may occur in the millimeter wave regime of the electromagnetic spectrum, where the effects of propagation loss and signal blockage may be significant. Thus, the use of beamforming at the UE device 600 (and/or at the base station) may be useful in mitigating such effects. To enhance the effectiveness of beamforming, the UE device 600 may provide reports of signal quality on one or more beams, e.g., as configured by the base station.

In some embodiments, the UE 600 (e.g., the processing element) may support carrier aggregation. Carrier aggregation (CA) involves the concatenation of a plurality of component carriers (CCs), which increases the bandwidth and data rate to and/or from the UE 600. When carrier aggregation is employed, the timing of frames may be aligned across cells involved in the aggregation. Different embodiments may support different maximum bandwidths and numbers of component carriers. In some embodiments, the UE 600 may concatenate component carriers from two or more base stations, of the same or different radio access technology. (For example, in some embodiments, the UE may perform carrier aggregation with an eNB of 3GG LTE and a gNB of 5G NR.) In some embodiments, the UE 600 may support both contiguous carriers and non-contiguous carriers.

In some embodiments, in a dual connectivity mode of operation, the processing element may direct a first RF chain to communicate with a first base station using a first radio access technology and direct a second RF chain to communicate with a second base station using a second radio access technology. For example, the first RF chain may communicate with an LTE eNB, and the second RF chain may communicate with a gNB of 5G New Radio (NR). The link with the LTE eNB may be referred to as the LTE branch. The link with the gNB may be referred to as the NR branch. In some embodiments, the processing element may include a first subcircuit for baseband processing with respect to the LTE branch and a second subcircuit for baseband processing with respect to the NR branch.

The processing element 610 may be further configured as variously described in the sections below.

### Wireless Base Station 700

In some embodiments, a wireless base station 700 of a wireless network (not shown) may be configured as shown in FIG. 7. The wireless base station may include: a radio subsystem 705 for performing wireless communication over a radio propagation channel; and a processing element 710 operatively coupled to the radio subsystem. (The wireless base station may also include any subset of the base station features described above, e.g., the features described above in connection with FIG. 5.)

The radio subsystem 710 may include one or more RF chains. Each RF chain may be tunable to a desired frequency, thus allowing the RF chain to receive or transmit at different frequencies at different times.

The processing element 710 may be realized as variously described above. For example, in one embodiment, processing element 710 may be realized by processor(s) 404. In some embodiments, the processing element may include one or more baseband processors to: (a) generate baseband signals to be transmitted by the radio subsystem, and/or, (b) process baseband signals provided by the radio subsystem.

In some embodiments, the base station 700 may include beamforming circuitry. The beamforming circuitry may be configured to receive uplink signals from respective antennas of an antenna array of the base station, and to apply receive beamforming to the uplink signals. For example, the beamforming circuitry may apply weights (e.g., complex weights) to the respective uplink signals, and then combine the weighted uplink signals to obtain a beam signal, where the weights define a reception beam. Different reception beams may be used to receive from different UE devices. The beamforming circuitry may also be configured to apply weights to respective copies of a downlink signal, and to transmit the weighted downlink signals via respective antennas of the antenna array of the base station, where the weights define a transmission beam. Different transmission beams may be used to transmit to different UE devices.

In some embodiments, the beamforming circuitry may be implemented by (or included in) the processing element 710. In other embodiments, beamforming circuitry may be included in the radio subsystem 705.

The processing element 710 may be configured to perform any of the base station method embodiments described herein.

### Types of Sounding Reference Signal (SRS) Usage

In some embodiments, several types of SRS are supported, with correspondingly different values of a “usage” parameter configured for the SRS resource set.

A first usage type may be described as SRS for codebook based transmission. (This usage type may be identified by usage=codebook.) For uplink full power transmission mode 2, a resource set of this usage type may be configured with up to 4 resources, and the number of configured ports may be different for different resources in the resource set. When the number of configured ports is smaller than the maximum number of ports supported by the UE, the UE may apply antenna virtualization to achieve full power transmission. For cases other than uplink full power transmission mode 2, a resource set of this usage type may be configured with up to 2 resources, and the number of configured ports may be required to be the same for SRS resources in the resource set.

A second usage type may be described as SRS for non-codebook based transmission. (This usage type may be identified by usage=nonCodebook.) Up to 4 resources may be configured in a resource set with of this usage type.

A third usage type may be described as SRS for antenna switching. (This usage type may be identified by usage=antennaSwitching.) The UE may perform antenna port switching in a resource set with this usage type, i.e., may switch antenna port(s) from one resource to another within the resource set. The UE may require a gap to be imposed between SRS resources, to allow for processing delay in the UE.

A fourth usage type may be described as SRS for beam management. In a resource set of this usage type, the UE may apply different beams to different SRS resources in the resource set. Furthermore, the gNB may apply different beams to receive different symbols/instances of the same SRS resource, in order to determine the best gNB-UE beam pair.

In some embodiments, SRS resources can only be configured with a single functionality per resource (or resource set). Thus, in order to achieve multiple purposes, gNB may need to trigger multiple SRS resources. For example, to measure uplink channel state information (CSI) for current transmission scheme (codebook or noncodebook), the gNB may need to trigger corresponding SRS resource set; and to measure downlink CSI, the gNB may need to separately trigger antenna SRS resource set for antenna switching. As another example, to measure uplink channel state information (CSI) for current transmission scheme (codebook or noncodebook), the gNB may need to trigger corresponding SRS resource set; and to measure beam quality, the gNB may need to separately trigger antenna SRS resource set for beam management.

### SRS Overhead Reduction: Resource Set for Codebook and Antenna Port Switching

In some embodiments, one SRS resource set can be used for both SRS transmission based on codebook and SRS transmission with antenna switching. A new value for the parameter “usage” may be added to an existing set of values, to identify this new type of resource set usage. (In the present disclosure, this new value will be denoted “codebook-antennaSwitching”.)

In some embodiments, this new usage type may not be configured for an SRS resource set where all SRS resources of the resource set have the same number of configured ports. (This usage type is not applicable for full power transmission mode 2.)

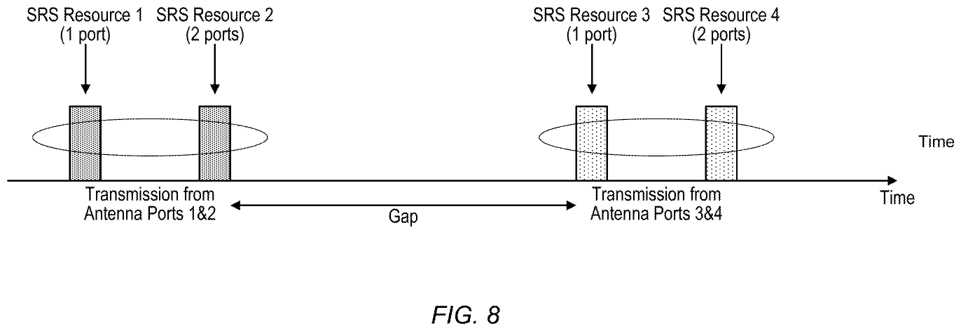

In some embodiments, if different numbers of ports are configured for different SRS resources in the resource set, the UE may switch the antenna port subset between SRS resources with the same number of ports, e.g., as shown in FIG. 8. (Alternatively, the UE may switch the antenna port subset between each successive pair of SRS resources in the resource set.) A gap should be reserved for UE processing delay for antenna switching.

In some embodiments, at most one SRS resource set may be configured with parameter “usage” equal to “codebook” or “codebook-antennaSwitching”. The indicated SRS resource indicator (SRI) in downlink control information (DCI) or in Radio Resource Control (RRC) configuration message is associated with the SRS resource in the configured resource set.

In alternative embodiments, the indicated SRI in DCI or RRC configuration information is associated with the SRS resources in the sets with “codebook” and “codebook-antennaSwitching”. In a first option, the order to determine SRI may be based on the SRS resource ID. Alternatively, in a second option, the order to determine SRI is based on SRS index within a set, where the resource set configured with usage equal to “codebook” is counted first, and then the resource set configured with usage equal to “codebook-antennaSwitching”.

In one example, two SRS resource sets are configured:

Set 1: codebook: {SRS resource 0, SRS resource 2};

Set 2: codebook-antennaSwitching: {SRS resource 1, SRS resource 3}.

Based on the first option, the order of an indicated 2-bit SRI would be SRS resource {0, 1, 2, 3}. Based on the second option, the order of an indicated 2-bit SRI would be SRS resource {0, 2, 1, 3}.

In some embodiments, a predefined rule may be used to determine whether an SRS resource set configured for codebook can be used for antenna switching. (A gap may be imposed between resources where antenna port switching occurs in the SRS resource set.)

For full power transmission mode 2, the UE may implement the predefined rule according to one of the following options.

According to a first option, the UE may switch antenna port(s) for different SRS resources in a resource set configured for codebook when the number of ports for the different SRS resources is configured to be the same.

According to a second option, UE may switch antenna port(s) for different SRS resources in a resource set configured for codebook when (a) the number of ports for the different SRS resources is configured to be the same and (b) the spatial relation for the different SRS resources is not configured.

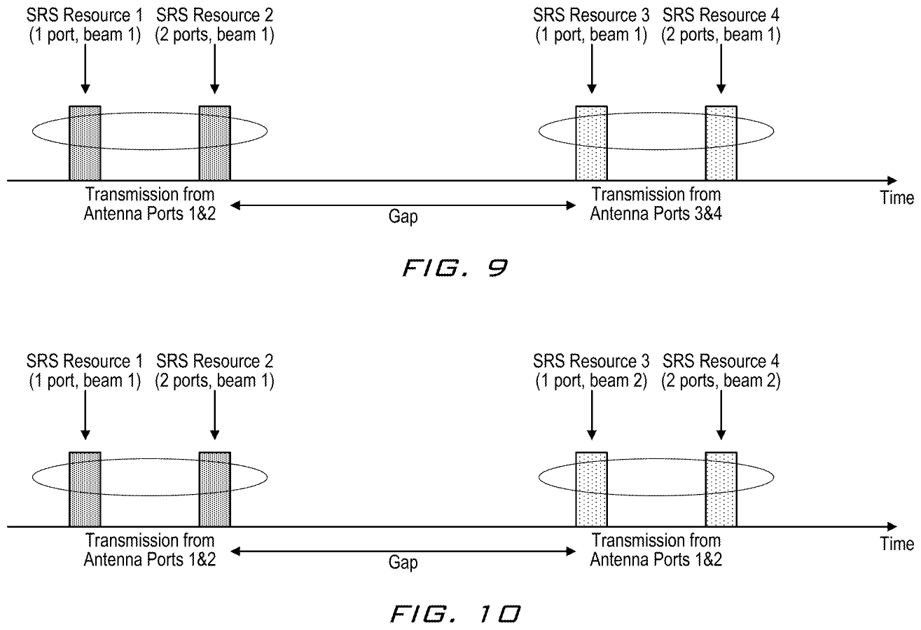

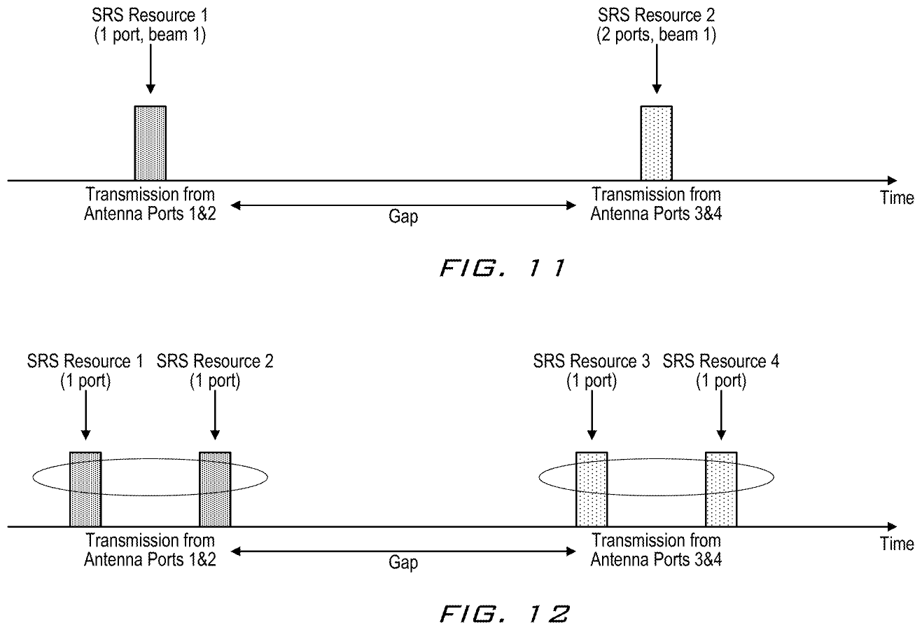

According to a third option, UE may switch antenna port(s) for different SRS resources in a resource set configured for codebook when (a) the number of ports for the different SRS resources is configured to be the same and (b) the spatial relation for the different SRS resources is configured to be the same. FIG. 9 illustrates an example where antenna switching (from antenna port subset {1,2} to antenna port subset {3,4}) is performed between SRS resource 2 and an SRS resource 3 since the number of ports is the same (2 ports) and the spatial relation is the same (beam 1) between them. FIG. 10 illustrates an example where antenna switching is not performed since there is no consecutive pair of SRS resources where both number of ports and spatial relation is the same. For example, between SRS resource 1 and SRS resource 2, the number of ports changes from 1 to 2; and between SRS resource 2 and SRS resource 3, the spatial relation changes from beam 1 to beam 2.

For cases other than full power transmission mode 2, the UE may implement the predefined rule according to one or more of the following options.

In a first option, the UE may switch antenna port(s) for different SRS resources in a resource set configured for codebook when the spatial relation for the different SRS resources is not configured.

In a second option, the UE may switch antenna port(s) for different SRS resources in a resource set configured for codebook when the spatial relation for the different SRS resources is configured to be the same.

In a third option, the UE may switch antenna port(s) for different SRS resources in a resource set configured for codebook when the offset between 2 SRS resources are larger than the gap for antenna switching.

FIG. 11 illustrates an example of the second option and third option in combination. The UE switches antenna port subsets (from port subset {1,2} to port subset {3,4}) between SRS resource 1 and SRS resource 2 in response to determining that the spatial relation (beam 1) is the same for both resources and that the gap between those resources is greater than or equal to a minimum gap time. For resource 1, the UE may select one of the antennas of the subset {1,2}, or use both antennas of the subset {1,2} with a virtualization weight vector [c₁,c₂]^{T} (e.g., a weight vector such as [1,1]^{T}/\sqrt{2}). For resource 2, since it is from two ports, both antennas of the subset {3,4} may be used.

### SRS Overhead Reduction: Resource Set for Non-Codebook and Antenna Switching

In some embodiments, an SRS resource set can be used for both non-codebook SRS transmissions and antenna port switching. (The UE may impose a gap between SRS resources when switching antenna ports.) A new value of the parameter “usage” may be added (to an existing set of values) to support his new usage type. In the present disclosure, this new value may be denoted “nonCodebook-antennaSwitching”.

In some embodiments, CSI reference signals are not configured for use in association with the resource set of this new usage type. (CSI is an acronym for Channel State Information.) For each 1-port SRS, the UE does not perform antenna virtualization.

The UE may perform antenna port switching between resources in an SRS resource set of usage type “nonCodebook-antennaSwitching” in response to one or more of the following conditions being satisfied.

According to a first condition, the UE may perform antenna port switching for all SRS resources in the SRS resource set.

According to a second condition, the UE may perform antenna port switching between SRS resources when the time offset is larger than a minimum gap length.

According to a third condition, the UE may perform antenna port switching for every K SRS resources.

FIG. 12 illustrates an example of the second and third conditions being applied in combination, with K=2. The UE performs antenna port switching (from port subset {1,2} to port subset {3,4}) between SRS resource 2 and SRS resource 3 in response to determining that the time gap (also referred to herein as “offset”) between those resources is greater than or equal to a minimum gap length, and that the transition from resource index 2 to 3 is a transition to a next group of K=2 resources within the resource set.

In some embodiments, the value of K may be configured by higher layer signaling, e.g., by Radio Resource Control (RRC) signaling. In other embodiments, the value of K may be determined by UE capability information such as the UE's maximum number of SRS ports (denoted X_{MAX}) and the UE's maximum number of downlink layers (denoted Y_{MAX}), e.g., according to the formula K=Y_{MAX}/X_{MAX}. The indicated SRS resources indicator(s) in downlink control information (DCI) or RRC signaling should not correspond to SRS resources that require antenna switching. As an example, for a 2Tx-4Rx UE, K= 4/2=2. (The expression “2Tx-4Rx” indicates a UE that has two transmit chains, four receive chains, and at least four physical antennas.) Thus, the UE may perform antenna port switching every 2 SRS resources in the SRS resource set.

In some embodiments, the UE may determine whether to perform antenna port switching in an SRS resource set of the “non-codebook” usage type based on a predefined rule that includes one or more conditions such as the following.

According to a first condition, the UE may perform antenna port switching if CSI reference signals are not configured is association with the SRS resource set.

According to a first condition, the UE may perform antenna port switching if no spatial relation is configured for the SRS resources in the SRS resource set, or, if spatial relations are configured but identical for the SRS resources in the SRS resource set.

According to a third condition, the UE may perform antenna port switching if an offset (i.e., a time difference) between SRS resources in the SRS resource set is greater than or equal to a minimum gap length for antenna switching.

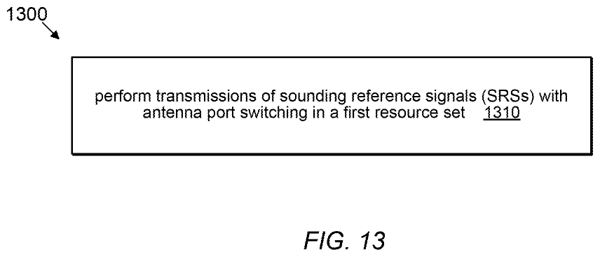

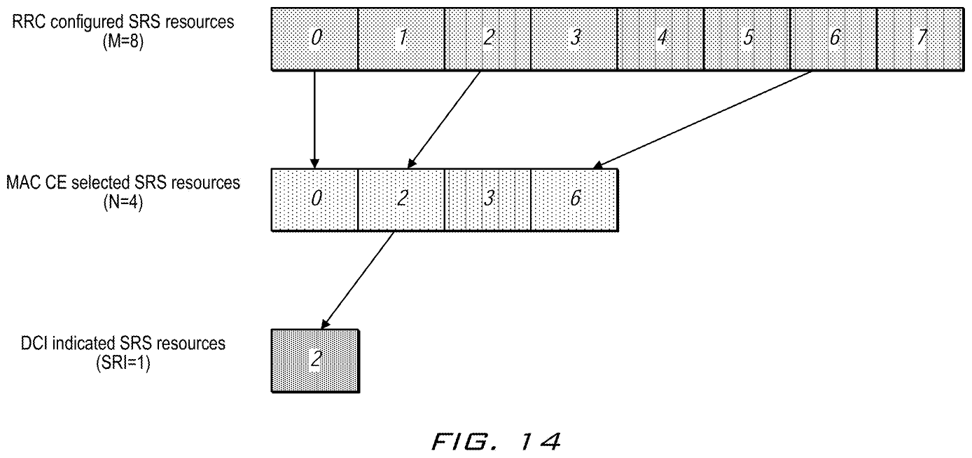

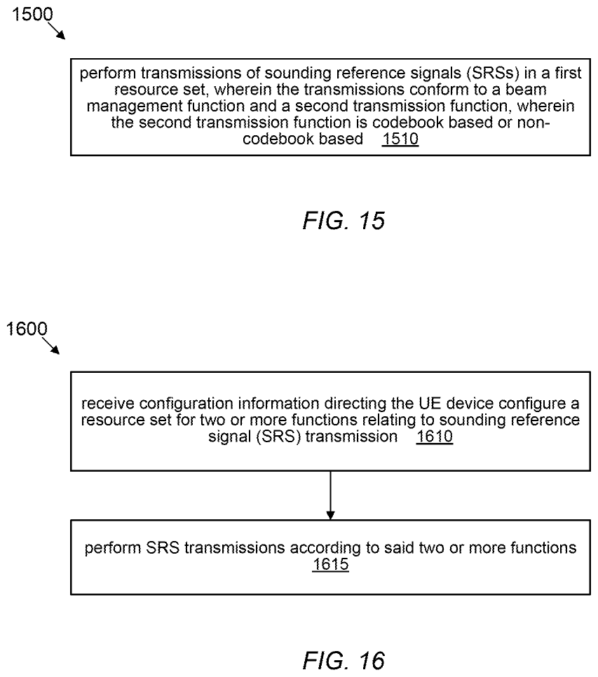

In some embodiments, a method 1300 for operating a wireless user equipment (UE) device may include the operations shown in FIG. 13. (The method 1300 may also include any subset of the elements, embodiments and features described above in connection with FIGS. 1-12 and below in connection with FIGS. 14-15.) The wireless UE device may be configured as variously described above, e.g., as described in connection with user equipment 600 of FIG. 6. The method 1300 may be performed by a processing element of the UE device.

At 1310, the processing element may perform transmissions of sounding reference signals (SRSs) with antenna port switching in a first resource set. The first resource set may include a plurality of SRS resources. Each of the SRS resources may include a corresponding array of time-frequency resource elements, and occupy a configured number of symbols in the uplink signal. Furthermore, the elements of the array may be spread in the frequency domain according to a configurable transmission comb. Other features of the SRS resource may be configurable, e.g., as described in 3GPP TS 38.211 and 28.314.

The SRS transmissions may be received by a base station (a gNB of 5G NR). The base station may use the received SRSs to estimate the channel between the UE device and the base station, e.g., between antennas of the UE device and antennas of the base station.

In some embodiments, the operation 1310 may be performed in response to receiving configuration information (e.g., RRC configuration information) from the base station, where the configuration information indicates that the first resource set is to be used for more than one SRS-related function, e.g., as variously described above.

In some embodiments, the SRSs may be associated with Physical Uplink Shared Channel (PUSCH) transmission for codebook based transmission scheme. (For example, each of the SRS transmissions may be transmitted using a precoding matrix or precoding vector from a precoding codebook. The codebook may be known to the base station. For example, the codebook may be predefined, or determined by configuration information transmitted by the base station.) In these embodiments, the first resource set may be configured using a value of a usage parameter (e.g., of a Radio Resource Control protocol) that indicates codebook usage and antenna switching.

In some embodiments, processing element may also configure resources of the first resource set so that not all the resources of the first resource set are configured for the same number of antenna ports. An antenna port may represent a virtual antenna, and be realized using a corresponding precoding vector in the codebook.

In some embodiments, the action of performing transmissions of SRSs with antenna port switching may include enabling (or performing) antenna port switching between a first resource and a second resource of the first resource set only when the first resource set and the second resource set have the same number of configured ports. For example, in FIG. 8, antenna port switching is enabled between the resource 1 and resource 3 since they both are configured for one port. Likewise, antenna port switching (from port subset {1,2} to port subset {3,4}) is enabled between resource 2 and resource 4 since they both are configured for two ports. A gap is imposed between resource 2 and 3 to provide sufficient time for the port switching.

In some embodiments, the action of performing transmissions of SRSs with antenna port switching is performed in response to a determination that a temporal gap between a last resource corresponding to a first subset of antenna ports and a first resource corresponding to a second subset of antenna ports is greater than or equal to a minimum value. The minimum value may be imposed so that the UE device will have sufficient time (e.g., processing time and/or hardware switching time) to switch between the antenna subsets. In the example shown in FIG. 8, the last resource corresponding to the first port subset is resource 2, and the first resource corresponding to the second port subset is resource 3.

In some embodiments, the processing element may also receive an SRS resource indicator (SRI) that indicates a particular resource from the first resource set. The particular resource may be used to transmit a Physical Uplink Shared Channel (PUSCH) to the base station. (Transmission according to the particular resource may include use of the antennas port and/or precoding associated with the particular resource.)

In some embodiments, the processing element may also receiving an SRS resource indicator (SRI) that indicates a particular resource from a union of one or more resource set of usage type equal to codebook and one or more resource sets of a usage type corresponding to codebook and antenna port switching. The particular resource may be used to transmit a PUSCH to the base station.

In some embodiments, the action of performing transmissions of SRSs with antenna port switching may include switching antenna ports between a first resource and a second resource of the first resource set in response to a determination that a switching condition is satisfied. The UE may evaluate the switching condition after receiving the control signaling (e.g., RRC configuration signaling) for an SRS resource set.

In some circumstances (e.g., if the UE device has been configured for full power transmission mode 2), the switching condition includes a first condition that the first resource and the second resource have the same number of configured ports. Furthermore, the switching condition may also include a second condition that the first resource and the second resource have the same spatial relation (e.g., beam indication) or have no configured spatial relation.

In some circumstances (e.g., if the UE device has not been configured for full power transmission mode 2), the switching condition may include one or more of the following conditions. As a first condition, the first resource and the second resource may be required to have the same spatial relation (e.g., beam indication), or have no configured spatial relation. As a second condition, the first resource and the second resource may be required to be separated by a time greater than or equal to a minimum gap time.

In some embodiments, the SRSs may be associated with Physical Uplink Shared Channel (PUSCH) transmission for non-codebook based transmission scheme (For example, the precoding may be determined by spatial relation information provided by the base station.) In these embodiments, the first resource set may be configured using a value of a usage parameter (e.g., of a Radio Resource Control protocol) that indicates codebook usage and antenna switching.

In some embodiments, the processing element may receive configuration information indicating that no channel state information (CSI) reference signals are associated with the first resource set. The action of performing SRS transmissions with antenna port switching may be performed in response to the UE's determination that the no CSI reference signals have been configured for the first resource set.

In some embodiments, each of the resources of the first resource set is configured with only one port and/or without antenna virtualization. The action of performing SRS transmissions with antenna port switching may be performed in response to the UE's determination that each of the resources of the first resource set is configured with only one port.

In some embodiments, the action of performing transmissions of SRSs with antenna port switching includes performing antenna port switching between each pair (or between a particular pair) of temporally consecutive resources in the first resource set.

In some embodiments, the action of performing transmissions of SRSs with antenna port switching includes performing antenna port switching between each pair (or between a particular pair) of temporally consecutive resources in the first resource set with time offset greater than or equal to a minimum gap time.

In some embodiments, the action of performing transmissions of SRSs with antenna port switching may include performing antenna port switching after every K^{th} resource within the first resource set, where K is a positive integer.

In some embodiments, the value of K may be determined by a configuration message received from a base station.

In some embodiments, the value of K may be determined by UE capability information, e.g., as variously described above.

In some embodiments, the action of performing transmissions of SRSs with antenna port switching may be performed in response to a determination that one or more conditions are satisfied. In one embodiment, the one or more conditions include a first condition that channel state information (CSI) reference signals are not configured for the first resource set. In another embodiment, the one or more conditions include a second condition that the spatial relation for all resources in the first resource set is configured to be the same or is not configured. In yet another embodiment, one or more conditions include a third condition that time offset between at least one temporally consecutive pair of resources in the first resource set is greater than or equal to a minimum gap time.

### SRS Overhead Reduction: SRS Resource Set for Codebook and Beam Management

In some embodiments, an SRS resource set can be used for both codebook-based SRS transmission and beam management. To support this new usage type, a new value of the parameter “usage” may be added to an existing set of values. In the present disclosure, the new value may be denoted “codebook-beamManagement”.

For this new type of SRS resource set, the gNB may configure up to M SRS resources, e.g., by RRC signaling. The gNB may down-select N of the M configured SRS resources, and indicate the down selected N resources to the UE, e.g., by transmission of MAC control element. (MAC is an acronym for Medium Access Control.) The maximum value of M and/or the value N may be based on a UE capability

In one embodiment, an SRI received by the UE from downlink control information (DCI) may indicate one of the N selected SRS resources. In another embodiment, the SRI received by UE from an RRC message may indicate one of the N selected SRS resources or one of the M configured SRS resources.)

FIG. 14 illustrates an example of M=8, N=4 and SRI=1. The UE device receives RRC signaling that directs the UE to configure M=8 SRS resources for a resource set of usage type “codebook-beamManagement”. The UE performs SRS transmission based on the resource set. The UE then receives a MAC CE identifying N=4 selected resources from the 8 SRS resources. The UE then receives SRI=1 (from DCI) that indicates a selected one of the 4 resources. SRI=1 points to the second resource of the 4 resources, i.e., the SRS resource 2. (As another example, SRI=3 would identify SRS resource 6.)

In some embodiments, the above described mechanism (of configuring M, selecting N, and indication of one by SRI) may be applied to a SRS resource set for both non-codebook-based SRS transmission and beam management.

In some embodiments, if the UE is not configured with uplink full power transmission mode 2, the number of ports for SRS resource(s) selected by MAC CE or configured by RRC may be required to be the same. Otherwise, different number of ports for SRS resource(s) can be configured.

In some embodiments, a method 1500 for operating a wireless user equipment (UE) device may include the operations shown in FIG. 15. (The method 1500 may also include any subset of the elements, embodiments and features described above in connection with FIGS. 1-14 and described below in connection with FIG. 16.) The wireless UE device may be configured as variously described above, e.g., as described in connection with user equipment 600 of FIG. 6. The method 1500 may be performed by a processing element of the UE device.

At 1510, the processing element may perform transmissions of sounding reference signals (SRS) in a first resource set, wherein the transmissions conform to (or implement) a beam management function and a second transmission function, wherein the second transmission function is codebook based or non-codebook based. According to the beam management function, the processing element may perform the SRS transmissions so that different resources in the first resource set are transmitted with different beams, e.g., based on a schedule or pattern determined by downlink configuration information. According to the second function, the processing element may perform the SRS transmissions so that one or more of resources in the first resource set are precoded, with or without use of a codebook.

In some embodiments, the first resource set may be configured using a value of a usage parameter (e.g., of a Radio Resource Control protocol) that indicates either codebook usage and beam management, or non-codebook usage and beam management.

The SRS transmissions may be received by a base station (e.g., a gNB of 5G NR). The base station may utilize the received sounding reference signals to estimate a transmission channel between the UE device and the base station, e.g., as variously described above.

In some embodiments, the processing element may configure m resources for the first resource set in response to receiving a first downlink message that indicates the m resources, where m is less than or equal to M. The parameter M may be based on a UE capability. (In one embodiment, the first downlink message may be a Radio Resource Control (RRC) configuration message transmitted from the base station.) This configuration operation occurs prior to the action of performing the SRS transmissions in the first resource set.

In some embodiments, the processing element may receive a second downlink message indicating N of the m resources, where N is less than m. (Alternatively, N may be less than or equal to m.) The second downlink message may, e.g., be a Medium Access Control (MAC) message, e.g., a MAC Control Element. The N indicated resources may be resources that the base station has selected from the m resources. For example, the N indicated resources may be the N best resources, based on a measure of resource quality such as SINR. (SINR is an acronym for signal to interference-and-noise ratio.)

In some embodiments, the processing element may receive an SRS resource indicator (SRI) that indicates a selected one of the N indicated resources. In one embodiment, the base station may transmit the SRI to the UE device as part of downlink control information (DCI).

In some embodiments, the processing element may receive an SRS resource indicator (SRI) that indicates a selected one of the m resources. In one embodiment, the base station may transmit the SRI to the UE device as part of an RRC message.

The UE device may use the selected resource to transmit data to the base station, e.g., to transmit a Physical Uplink Shared Channel (PUSCH). The data transmission may utilize the antenna port(s) and/or beam associated with the selected resource.

In some embodiments, the processing element may configure the first resource set for said beam management function and said second function in response to determining that (a) the UE device is not configured for a particular uplink full power transmission mode and (b) the number of ports associated with each of the m resources is the same. The particular uplink (UL) full power transmission mode may be uplink full power transmission mode 2. In this transmission mode, the gNB may configure N SRS resources in a set for UL codebook-based transmission, where different numbers of ports can be configured in different SRS resources. For an M Tx UE device, when less than M port SRS is configured, the UE device may use antenna virtualization to achieve full power transmission. (An M Tx UE device is a UE device that has M RF transmission chains, where M is a positive integer.) Full power transmission may require the UE device to utilize all the Tx ports; thus with antenna virtualization, all the antenna ports may be non-zero-power basis.

In some embodiments, the N resources indicated by the second downlink message are required to have the same number of associated antenna ports. For example, the base station may impose this requirement on the N resource that it selects and indicates to the UE device.

In some embodiments, a method 1600 for operating a wireless user equipment (UE) device may include the operations shown in FIG. 16. (The method 1600 may also include any subset of the elements, embodiments and features described above in connection with FIGS. 1-15.) The wireless UE device may be configured as variously described above, e.g., as described in connection with user equipment 600 of FIG. 6. The method 1600 may be performed by a processing element of the UE device.

At 1610, the processing element may receive configuration information (e.g., a value of a Radio Resource Control usage parameter) directing the UE device to configure an SRS resource set for two or more functions relating to sounding reference signal (SRS) transmission. The two or more functions may be selected from a set of SRS-related functions.

In some embodiments, the function set may include at least: codebook-based transmission; and antenna port switching between SRS resources. In other embodiments, the function set may include at least: non-codebook based transmission; and antenna port switching between SRS resources. In yet other embodiments, the function set may include at least: codebook-based transmission; and beam management. In yet other embodiments, the function set may include at least: non-codebook-based transmission; and beam management. In yet other embodiments, the function set may include: codebook-based SRS transmission; non-codebook based SRS transmission; antenna port switching between SRS resources; and beam management. A wide variety of other realizations of the function set are possible.

At 1615, the processing element may perform SRS transmissions according to said two or more functions, e.g., as variously described in the present disclosure.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a computer system may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The computer system may be realized in any of various forms. For example, the computer system may be a personal computer (in any of its various realizations), a workstation, a computer on a card, an application-specific computer in a box, a server computer, a client computer, a hand-held device, a user equipment (UE) device, a tablet computer, a wearable computer, a computer implanted in a biological organism, etc.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the embodiments above have been described in considerable detail, numerous variations and modifications will become apparent to those skilled in the art once the above disclosure is fully appreciated. It is intended that the following claims be interpreted to embrace all such variations and modifications.

1. A method for operating a wireless user equipment (UE) device, the method comprising:
performing operations on a processing element, wherein the operations include:
performing transmissions of sounding reference signals (SRSs) with antenna port switching in a first resource set.

2. The method of claim 1, wherein the SRSs are associated with Physical Uplink Shared Channel (PUSCH) transmission for codebook based transmission scheme.

3. The method of claim 2, wherein the first resource set is configured using a value of a usage parameter that indicates codebook usage and antenna switching.

4. The method of claim 2, wherein the operations also include configuring resources of the first resource set so that not all the resources are configured for the same number of antenna ports.

5. The method of claim 2, wherein said performing transmissions of sounding reference signals (SRSs) with antenna port switching includes enabling antenna port switching between a first resource and a second resource of the first resource set only when the first resource set and the second resource set have the same number of configured ports.

6. The method of claim 2, wherein said performing transmissions of sounding reference signals (SRSs) with antenna port switching is performed in response to determine that a temporal gap between a last resource corresponding to a first subset of antenna ports and a first resource corresponding to a second subset of antenna ports is greater than or equal to a minimum value.

7. The method of claim 2, wherein the operations also include:
receiving an SRS resource indicator (SRI) that indicates a particular resource from the first resource set.

8. The method of claim 2, wherein the operations also include:
receiving an SRS resource indicator (SRI) that indicates a particular resource from a union of one or more resource set of usage type equal to codebook and one or more resource sets of a usage type corresponding to codebook and antenna port switching.

9. The method of claim 2, wherein said performing transmissions of sounding reference signals (SRSs) with antenna port switching includes switching antenna ports between a first resource and a second resource of the first resource set in response to a determination that a switching condition is satisfied.

10-13. (canceled)

14. The method of claim 1, wherein the SRSs are associated with Physical Uplink Shared Channel (PUSCH) transmission for non-codebook based transmission scheme.

15-21. (canceled)

22. A method for operating a wireless user equipment (UE) device, the method comprising:
performing operations on a processing element, wherein the operations include:
performing transmissions of sounding reference signals (SRSs) in a first resource set, wherein the transmissions conform to a beam management function and a second transmission function, wherein the second transmission function is codebook based or non-codebook based.

23. The method of claim 22, wherein the first resource set is configured using a value of a usage parameter that indicates either codebook usage and beam management, or non-codebook usage and beam management.

24. The method of claim 22, wherein the operations also include configuring m resources for the first resource set in response to receiving a first downlink message that indicates the m resources, wherein m is less than or equal to M, wherein M is based on a UE capability.

25-26. (canceled)

27. The method of claim 22, wherein the operations also include:
configuring the first resource set for said beam management function and said second function in response to determining that (a) the UE device is not configured for a particular uplink full power transmission mode and (b) the number of ports associated with each of the m resources is the same.

28. The method of claim 22, wherein the N resources indicated by the second downlink message have the same number of associated ports.

29. A method for operating a wireless user equipment (UE) device, the method comprising:
performing operations on a processing element, wherein the operations include:
receiving configuration information directing the UE device to configure a sounding reference signal (SRS) resource set for two or more functions relating to SRS transmission, wherein the two or more functions belong to a set of SRS-related functions;
perform transmissions of SRSs according to said two or more functions.

30. The method of claim 29, wherein the function set includes at least:
codebook-based transmission; and
antenna port switching between SRS resources.

31. The method of claim 29, wherein the function set includes at least:
non-codebook based transmission; and
antenna port switching between SRS resources.

32. The method of claim 29, wherein the function set includes at least:
codebook-based transmission; and
beam management.

33. The method of claim 29, wherein the function set includes at least:
non-codebook-based transmission; and
beam management.
